(19) United States
(12) Patent Application Publication
(10) Pub. No.: US 2019/0283721 A1
(43) Pub. Date: Sep. 19, 2019

(54) METHODS AND SYSTEMS FOR ADAPTIVELY CONTROLLING RAILCAR STOPPING DISTANCE BASED ON ENVIRONMENTAL CONDITIONS

(71) Applicant: Metrom Rail, LLC, Crystal Lake, IL (US)

(72) Inventors: Richard C. Carlson, Palatine, IL (US); Kurt A. Gunther, Woodstock, IL (US)

(21) Appl. No.: 16/353,306

(22) Filed: Mar. 14, 2019

Related U.S. Application Data
(60) Provisional application No. 62/642,948, filed on Mar. 14, 2018.

(51) Int. Cl. B60T 8/17; B60T 8/172; G05B 13/02

(52) U.S. Cl. CPC B60T 8/1705; G05B 13/0205; B60T 8/172

(57) ABSTRACT

Systems and methods are provided for adaptively controlling railcar stopping distance based on environmental conditions related solutions.

### CLAIM OF PRIORITY

This patent application claims priority to and claims benefit from U.S. Provisional Patent Application Ser. No. 62/642,948, filed on Mar. 14, 2018. The above identified application is hereby incorporated herein by reference in its entirety.

### TECHNICAL FIELD

Aspects of the present disclosure relate to control solutions in conjunction with railway systems. More specifically, various implementations of the present disclosure relate to methods and systems for adaptively controlling railcar stopping distance based on environmental conditions and use thereof in conjunction with railway systems.

### BACKGROUND

Various issues may exist with conventional approaches for controlling traffic in train systems. In this regard, conventional solutions, if any existed, for controlling trains, particularly with respect to controlling stopping distances, may be ineffective, inefficient, costly, and cumbersome.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for adaptively controlling railcar stopping distance based on environmental conditions, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 illustrates an example train system that incorporates solutions for adaptively controlling railcar stopping distance based on environmental conditions, in accordance with the present disclosure.

FIG. 2 illustrates a flowchart of an example process for adaptively controlling railcar stopping distance based on environmental conditions, in accordance with the present disclosure.

### DETAILED DESCRIPTION OF THE INVENTION

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

The present disclosure is directed to enhanced control solutions for use in trains and railway systems, particularly to ensure achieving specific stopping distances. In this regard, by its nature, a stopping distance of a train is typically dependent on the friction between wheels of the railcars and the track, and as such may typically be dependent on any factors or conditions that may affect this friction. In this regard, when a railcar decelerates, friction between the wheels of a railcar and the track may be the predominantly controlling factor as to how long the railcar will take to stop at a given speed. This friction and thus the stopping distances may be highly dependent upon environmental factors for consistent stopping distances, however. For example, the stopping distance of a railcar may be substantially affected (e.g., increased, by up to 10× in some instances) due to such factors as moisture—that is, being dependent upon the amount of moisture on the tracks.

Accordingly, in various implementations in accordance with the present disclosure, trains may be configured to incorporate automated control solutions for adaptively controlling stopping distances based on environmental conditions, such as by adaptively controlling train systems and/or functions that facilitate or contribute to stopping the train (e.g., braking systems and/or functions in the train) based on these environmental conditions. In this regard, the proposed automated control solutions may be configured to take into consideration (e.g., when controlling the braking systems and/or functions) various factors, including environmental conditions in particular, such as amount of moisture on the tracks, which may affect railcar stopping distances. In other words, the proposed automated control solutions may be configured for controlling stopping distances (e.g., ensuring that a particular stopping distance is achieved) based on real-time environmental conditions, such as by adaptively controlling the brakes (e.g., applying the brakes earlier, harder, etc.) based on the real-time environmental conditions.

For example, the automated control solutions may be configured to achieved desired stopping distances by controlling the timing of the brakes (e.g., when to apply the brakes), specifically based on real-time measurements or other information relating to environmental conditions affecting the tracks. In this regard, for trains to safely operate, initiation of braking must be done at a proper distance in advance of a desired stopping point. With train manual operation, the operator must anticipate the necessary braking distance and initiate brake application at the appropriate point. With automatic train operation, train control systems may compute the worst-case braking distance to ensure that the train will stop at or before the desired stopping point.

Various factors and/or operating conditions must be considered when determining the worst-case braking distance of a train to program into the train's braking algorithm. In this regard, with automatic train operation, determining the required braking distance is a complex task, and the resulting braking algorithm may have a significant impact on operations.

For example, if the worst-case braking calculations are done overly conservative manner, under nominal operating conditions, the resulting computations may cause trains to stop an excessive distance prior to the desired stopping point. This in turn will result in larger train separation distances, reducing the throughput or capacity of the line. With increasing urban populations, stopping trains prematurely is problematic since many transit agencies are struggling to achieve the required density of trains to move their riders during peak transit periods. In contrast, worst-case stopping distance which is too optimistic may also result in undesirable outcomes and/or safety issues. For example, in the case of slippery rails, with a worst-case stopping distance that is too optimistic, the train may not be capable of stopping as fast as necessary because the friction between the wheels and the track is reduced, and as a result the train may only stop past the desired (or intended) stopping point—that is, the train may overshoot its intended stopping point. Such overshooting may be inconvenient, unfortunate, unsafe, and/or disastrous.

In this regard, overshooting the intended stopping point may be inconvenient because riders may be waiting at their “usual spot” in the station, but the train may stop beyond them, forcing them to walk some distance at the station to reach the train doors. Overshooting the intended stopping point may also be unfortunate because when the train overshoots the station, some doors may not align with the station, a situation that may not be readily addressed during normal train operations. In this regard, most, if not all transit authorities prohibit backing up trains once they stop at stations, and as such some riders may not be able to disembark some of railcars (e.g., those that went past the station platform as a result of the overshooting) because the doors may not be opened away from the station. Overshooting the intended stopping point may also be unsafe because when the train overshoots the station, the operator may fail to notice that and may open doors that are not at the station. As a result, riders not paying attention may step out and fall to the track bed, and may possibly even fall through the track structure on the elevated track resulting in severe injuries or death. Overshooting the intended stopping point may be disastrous because when the train overshoots the station, the train may overrun a restrictive signal and strike a stopped train in the next block, or the train strike a track switch that is not properly aligned and derail the train.

As a result, it is important that the worst-case stopping distance be adequate, but not overly so. Accordingly, the automated control solutions in accordance with the present disclosure may be configured to perform the worst-case braking distance determined in optimal manner. In this regard, the challenge with worst-case braking distance calculations for automatic train operation systems is that assuming the worst-case condition for all parameters will result in a braking distance which is significantly greater than necessary in normal operating conditions. Worst-case factors which are considered in these calculations include the time delays for vital processing, propulsion removal, and brake activation. Additional factors which extend the calculated braking distance significantly include the allowance for worst-case data latency, the grade (slope) of the track, degraded braking systems on the train, and degraded conditions on the rail surface.

Thus, optimal system performance may be achieved when the stopping distance calculation is based upon actual operating conditions. For example, the grade of the track has an impact on the stopping distance. Accordingly, the grade of track is continuously identified according to the train location and is used to compensate the safe braking model to prevent an excessively early or late brake application. For example, one of the most contentious of factors in worst-case braking distance calculations is the allowance for poor adhesion between the train wheel and the rail.

Conditions that may reduce the adhesion (friction) include wet rails, which may be caused by dew, rain, freezing rain, frost, or snow; and other contaminants such as dirt or other debris between the wheel and the rail. Possibly the most notable debris to consider is leaves falling on the rails in autumn. When leaves land on the rails, and are crushed by the train wheels, they leave a slippery pectin film on the rails, which is very slippery when wet.

Among the variables that affect the stopping distance which must be considered for worst-case braking distance calculations, rail adhesion (friction) may be the predominant controlling factor determining the distance required for the train to stop at a given speed. Compared to nominal clean and dry rail, the stopping distance of a passenger train may easily double in rainy conditions. If the rail is icy, the stopping distance may be triple the stopping distance when the rail is clean and dry. If the rails are covered with slippery, wet leaves, the stopping distance may quadruple (increase by a factor of 4), possibly even more. Allowing for these worst-case conditions at all times may result in a train stopping short of the target in nominal conditions, and by significant distances in some instances (e.g., 500 to 1,000 feet), significantly reducing train density and slowing operations.

Thus, with the proposed control solutions, the train may adjust the timing of application of the brakes—i.e., set the point (in time) where the brakes are applied to an earlier positing, as the train may require a longer distance with the current conditions, to ensure that the train comes to stop at the desired stopping point (in space), and thus reducing if not eliminate issues relating to overshooting desired stopping points (in space).

An example system for controlling operations of a train, in accordance with the present disclosure, may include one or more circuits configured to obtain sensory information relating to a track traversed by the train; in response to a determination that the train needs to stop, determine a target stopping point; and determine based on the sensory information, one or more control adjustments applicable to at least one component in the train that facilitates or contributes to stopping of the train. The one or more control adjustments may be configured to ensure stopping the train at the target stopping point.

In an example implementation, the at least one component may include a braking system of the train.

In an example implementation, the one or more circuits may be configured to set or adjust at least one control adjustment to modifying timing of application of braking via the braking system.

In an example implementation, the one or more circuits may be configured to obtain at least a portion of the sensory information from sources external to the train.

In an example implementation, the system may include one or more sensors configured to generate the sensory information.

In an example implementation, the sensory information may include information relating to one or more environmental conditions at or near the tracks, and the at least one of the one or more sensors may be configured to obtain measurements relating to at least one of the one or more environmental conditions.

In an example implementation, the at least one of the one or more environmental conditions may include moisture, and the at least one of the one or more sensors may include a moisture sensor.

In an example implementation, the at least one of the one or more sensors may be configured to generate at least a portion of the sensory information based on tracking of one or more characteristics associated with a wheel of the train.

In an example implementation, the one or more circuits may be configured to obtain operation information relating to operation of the train on the track; and determine or adjust at least one of the one or more control adjustments based on the operation information.

An example method for controlling operations of a train, in accordance with the present disclosure, may include obtaining sensory information relating to a track traversed by the train; in response to determination that the train needs to stop, determining a target stopping point; and determining based on the sensory information, one or more control adjustments applicable to at least one function used in the train to facilitate or contribute to stopping of the train. The one or more control adjustments may be configured to ensure stopping the train at the target stopping point.

In an example implementation, the at least one function may include a braking related function in the train.

In an example implementation, the method may include setting or adjusting at least one control adjustment to modifying timing of application of the braking related function.

In an example implementation, the method may include obtaining at least a portion of the sensory information from sources external to the train.

In an example implementation, the method may include obtaining at least a portion of the sensory information via one or more sensors in the trains.

In an example implementation, the sensory information may include information relating to one or more environmental conditions at or near the tracks. The at least one of the one or more environmental conditions may include moisture.

In an example implementation, the method may include obtaining measurements relating to at least one of the one or more environmental conditions; and generating at least a portion of the information relating to one or more environmental conditions based on the obtained measurements.

In an example implementation, the method may include generating at least a portion of the sensory information based on tracking of one or more characteristics associated with a wheel of the train.

In an example implementation, the method may include obtaining operation information relating to operation of the train on the track; and determining or adjust at least one of the one or more control adjustments based on the operation information. The operation information may include information relating to one or more of: speed of the train, weight of the train, length of the train, speeds, grade, and grade of the track.

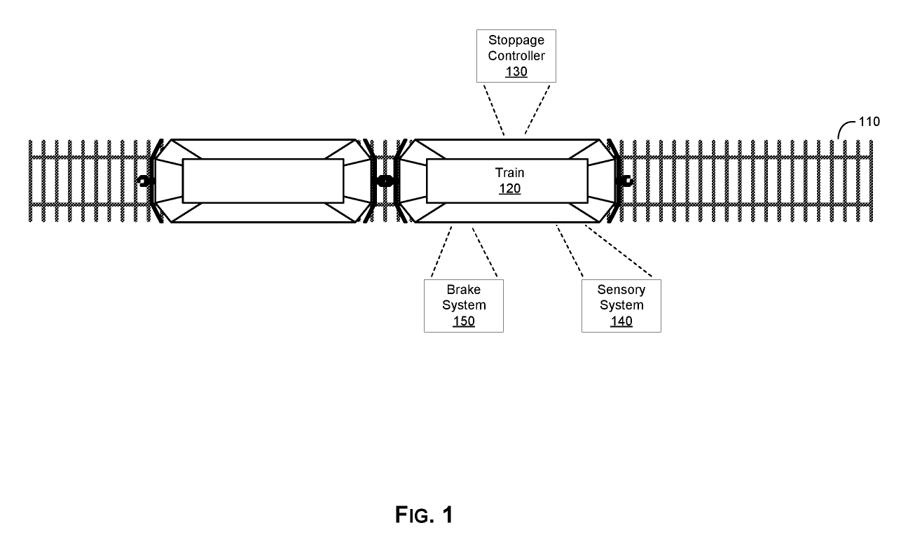

FIG. 1 illustrates an example train system that incorporates solutions for adaptively controlling railcar stopping distance based on environmental conditions, in accordance with the present disclosure. Shown in FIG. 1 is a train 120 which is configured for, and/or incorporates systems/component for adaptively controlling railcar stopping distance based on environmental conditions, and an example use scenario thereof.

The train 120 may be configured for supporting controlling stopping distances in an adaptive and enhanced manner, particularly by incorporating an automated braking control process that takes into consideration factors that may affect stopping distances (e.g., moisture on tracks). For example, as shown in FIG. 1, the train 120 may incorporate a stopping controller 130 and a sensory system 140. In this regard, the stopping controller 130 may comprise suitable circuitry for managing and controlling train functions that may affect stopping distances (e.g., braking functions, which may be performed via a braking system 150, incorporated into the train 120).

The sensory system 140 may comprise suitable circuits for handling obtaining sensory information pertinent to the distance stopping functions. The sensory information may be obtained from on-train sensors—e.g., sensors incorporated directly into the train 120. The sensory information may also be obtained from external sources (e.g., wayside sensors deployed into and near the tracks, other trains having on-train sensors, etc.). Further, in some instances, the sensory information may be obtained from a localized conditions monitoring service (implemented, e.g., via suitable servers or computer systems), which may be configured to monitor and detect conditions or events that may affect train stopping distances (e.g., meteorological conditions or events), through various means, and provide indications to trains (when necessary) that stopping performance may be affected. For example, such services may be configured to assess detected local environmental conditions (e.g., local weather conditions), such as based upon programmed computing rules and/or human judgement, to determine whether these conditions may indicate a risk of degraded track conditions, and as a result, whether adjustment of stopping distances may need to be implemented, and generate corresponding sensory indications. The sensing indications may be communicated directly to the trains via suitable means—e.g., via cellular connections, a secure VPN gateway connected the wireless data communication system, which may provide data connectivity to the trains, and/or via available centralized train control systems. Such sensing indications may be system-wide, or in large transit systems or transit systems with varied geography, may be targeted to specific regions within the transit system (or even to specific trains and/or track sections).

Once the sensory information is collected (and optionally subjected to initial processed in the sensory system 140, such as to convert the information into a format used or supported by the stopping controller 130), the sensory information may be provided to the stopping controller 130. The stopping controller 130 may then use the sensory information to control and/or manage stopping related functions or operations in the train 120, such as braking functions, by controlling or otherwise affecting operations of the braking system 150, for example.

In this regard, as noted above the braking distance of a rail vehicle may be affected by several factors, which collectively encompass or define the “braking curve.” The braking curve may be the calculation of stopping distance for particular train (or vehicle/railcar thereof) at specific train weights, speeds, grade, and consistent length(s). Specifically, stopping trains poses unique issues and challenges. In this regard, brake systems available on trains typically stop or slow the train at a specific deceleration factor, which may not be adjustable. For example, unlike other means for transportation (e.g., an automobile or truck), a train may lack the ability to allow for adjusting the amount of braking (e.g., by “pushing the peddle down harder”) to achieve a shorter stopping distance.

As braking distances are drastically altered in certain situations and/or under certain conditions—e.g., when the rail is wet, snowy, or icy, the only way to stop at a desired point under these conditions is to start braking earlier. In this regard, existing trains' braking systems may be applied manually (e.g., by train operators), or automatically, by a train control system. Existing train brake systems and/or control systems used in conjunction therewith may not be able to operate in adaptive manner based on certain environment conditions—e.g., may not have the capability to adjust braking activation points to account for these “wet rail” stops.

Accordingly, solutions in accordance with the present disclosure address such issues. For example, the sensory system 140 may obtain sensory information relating to conditions affecting to braking distances. For example, the sensory system 140 may comprise (or interact with) moisture/humidity sensors to obtain sensory information relating to moisture/humidity on tracks 110 traversed by the train 120.

The stopping controller 130 may then use this information to control stopping distances and/or functions pertinent to stopping distances based on moisture/humidity of the tracks 110. For example, when reading(s) from such moisture/humidity sensor(s) meet certain conditions—e.g., exceed pre-determined threshold(s), the stopping controller 130 may adaptively respond, such as by causing the braking system 150 to allow and/or account for increased stopping distance. This may be done, in an example implementation, by utilizing a software algorithm (e.g., executed via the stopping controller 120) which causes applying the braking system 150 earlier, to provide stopping at the desired point.

The incorporation of such moisture/humidity sensory based control into braking system in the train will allow for an automated braking process that compensates for extreme conditions (e.g., by triggering and/or sending control signal(s)), such as when wet conditions are detected, allowing the train to stop in a shorter distance by using an alternate braking profile algorithm. In this regard, the alternate braking profile algorithm, used in the “wet” environments, may be a simple alternate algorithm, or a more advanced “adaptive” algorithm.

As noted above, the sensors may be deployed (or incorporated) into the train and/or external to the train (e.g., wayside locations). In this regard, the sensors' positions or locations may be selected adaptively to optimize operations. For example, on-train sensors may be located on the outside of the train (and near the tracks), in order to sense local exterior environment, allowing ambient external air to enter.

In an example implementation, the sensory information (e.g., as obtained by the sensory system 140) may comprise information that are indicative (indirectly) of environmental conditions affecting traction rather than being actual measurements of the environmental conditions. For example, the sensory system 140 may be configured to automatically detect wheel slippage (e.g., short intervals of reduced deceleration), and generate indications when such slippage occurs, which may in turn result in triggering stopping distance adjustment measures—e.g., automatically switching to a slippery track setting for braking.

In an example implementation, additional components may be incorporated into trains for assisting in achieved desired stopping performance. For example, trains may incorporate equipment for enhancing track traction—e.g., traction sand application devices. Such traction enhancement equipment may be configured for taking particular actions for causing traction with the track to improve, thus allowing achieving stopping distances that are similar or close to normal conditions. For example, traction sand application devices may be configured to apply fine sand in front of the first wheels on the railcar to improve traction.

The traction enhancement equipment may be utilized manually or automatically. For example, with manual mode of operation, when conditions that may affect stopping distances are detected and their effects are assessed (and determined to adversely affect stopping distances), the system may notify the train operator (e.g., via audible, visual, etc. indications) to consider activating available traction enhancement equipment. With automatic mode of operation, the system may be configured to proactively initiate activation of such traction enhancement equipment, such as based on predefined criteria.

In an example implementation, centralized systems may be used in support of adaptive stopping distance control solutions. For example, in some instances a central server may be used to manage and control trains' braking curves, and to control adaptive stopping distance control based thereon. Thus, where such central server is used, and communications therewith is available, the central server may be configured to determine any needed adjustments to the train's braking curve, such as by assessing reported conditions (e.g., received form the train or other local sources), and when necessary issuing a command to adjust braking function—e.g., by using a longer braking algorithm.

Example conditions or situations where such longer braking algorithm may be triggered may include: freezing rain (rain during freezing conditions such that ice may accumulate on the tracks), wet snow followed by freezing conditions, rain occurring while leaves are actively falling from trees, rain after a long dry period, particularly in the summer, which may be particularly problematic in the with presence of oily deposits and/or other contaminants on the tracks that may become slippery briefly, etc.

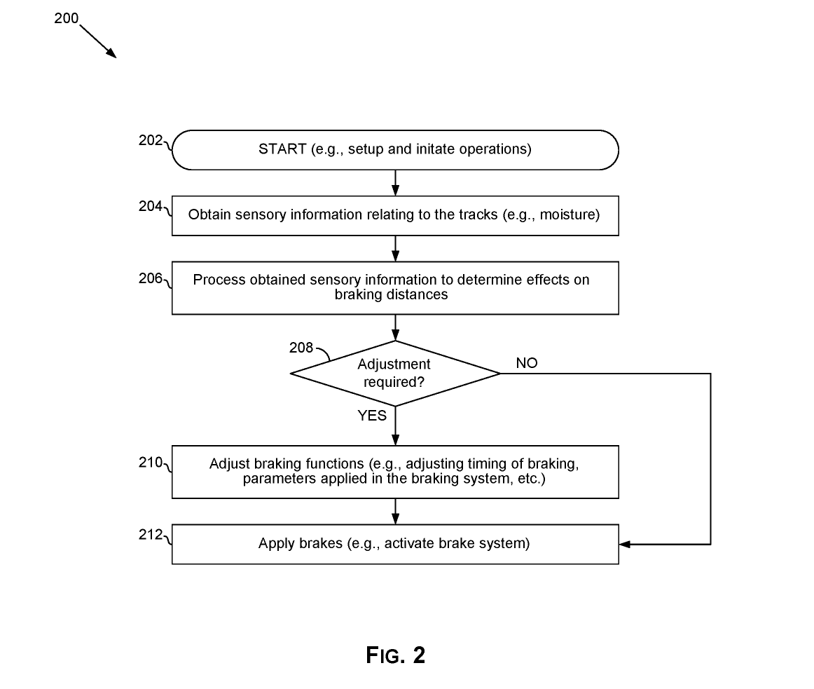

FIG. 2 illustrates a flowchart of an example process for adaptively controlling railcar stopping distance based on environmental conditions, in accordance with the present disclosure. Shown in FIG. 2 is flow chart 200, comprising a plurality of example steps (represented as blocks 202-212), which may be performed to reduces stopping distance.

In starting step 202, system(s) used in performing the process (e.g., the stopping controller 120, the sensory system 130, etc. of FIG. 1) may be setup and/or initiate operation.

In step 204, sensory information relating to the tracks (e.g., moisture/humidity, etc.) may be obtained. For example, with reference to the example implementation shown in FIG. 1, the sensory system 140 may obtain sensory information relating to track 110. In this regard, the sensory information may be obtained from on-train sensors, wayside sensors, and/or from other external sources (such as other trains, etc.) which may provide the sensory information via message(s) sent via wireless communication network(s).

In step 206, the obtained sensory information may be obtained, specifically to determine effects of corresponding environmental conditions (e.g., moisture/humidity on tracks) on braking distances. For example, the stopping controller 130 may process sensory information obtained and provided by the sensory system 140, such as using pre-programmed braking system control algorithm run thereby.

In step 208, it may be determined whether adjustments to braking operations (or related parameters) may be required. For example, processing the obtained sensory information may comprise determining when/if the corresponding conditions meet pre-defined thresholds that require adjusting braking, such as by applying brakes earlier to allow for increased braking distance. In instances where it may be determined that no adjustments are required, the process may skip directly to step 212; otherwise, the process may proceed to step 210.

In step 210, braking may be adjusted in the manner determined in the prior step—e.g., by adjusting parameters applied in the braking system. For example, the timing of application of the braking system may be modified, such as to allow for increasing stopping distance by particular factors (e.g., based on a modified braking curve).

In step 212, the brakes may be applied (when there is a need to stop the train), such as by activating brake system.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for controlling operations of a train, the system comprising:
one or more circuits configured to:
obtain sensory information relating to a track traversed by the train;
in response to determination that the train needs to stop, determine a target stopping point; and
determine based on the sensory information, one or more control adjustments applicable to at least one component in the train that facilitates or contributes to stopping of the train,
wherein the one or more control adjustments are configured to ensure stopping the train at the target stopping point.

2. The system of claim 1, wherein the at least one component comprises a braking system of the train.

3. The system of claim 2, wherein the one or more circuits are configured to set or adjust at least one control adjustment to modifying timing of application of braking via the braking system.

4. The system of claim 1, wherein the one or more circuits are configured to obtain at least a portion of the sensory information from sources external to the train.

5. The system of claim 1, comprising one or more sensors configured to generate the sensory information.

6. The system of claim 5, wherein the sensory information comprises information relating to one or more environmental conditions at or near the tracks, and wherein at least one of the one or more sensors is configured to obtain measurements relating to at least one of the one or more environmental conditions.

7. The system of claim 5, wherein the at least one of the one or more environmental conditions comprises moisture, and wherein the at least one of the one or more sensors comprises a moisture sensor.

8. The system of claim 5, wherein at least one of the one or more sensors is configured to generate at least a portion of the sensory information based on tracking of one or more characteristics associated with a wheel of the train.

9. The system of claim 1, wherein the one or more circuits are configured to:
obtain operation information relating to operation of the train on the track; and
determine or adjust at least one of the one or more control adjustments based on the operation information.

10. A method for controlling operations of a train, the method comprising:
obtaining sensory information relating to a track traversed by the train;
in response to determination that the train needs to stop, determining a target stopping point; and
determining based on the sensory information, one or more control adjustments applicable to at least one function used in the train for facilitating or contributing to stopping of the train,
wherein the one or more control adjustments are configured to ensure stopping the train at the target stopping point.

11. The method of claim 10, wherein the at least one function comprises a braking related function in the train.

12. The method of claim 11, comprising setting or adjusting at least one control adjustment to modifying timing of application of the braking related function.

13. The method of claim 10, comprising obtaining at least a portion of the sensory information from sources external to the train.

14. The method of claim 10, comprising obtaining at least a portion of the sensory information via one or more sensors in the trains.

15. The method of claim 10, wherein the sensory information comprises information relating to one or more environmental conditions at or near the tracks.

16. The method of claim 15, wherein the at least one of the one or more environmental conditions comprises moisture.

17. The method of claim 15, comprising:
obtaining measurements relating to at least one of the one or more environmental conditions; and
generating at least a portion of the information relating to one or more environmental conditions based on the obtained measurements.

18. The method of claim 10, comprising generating at least a portion of the sensory information based on tracking of one or more characteristics associated with a wheel of the train.

19. The method of claim 10, comprising:
obtaining operation information relating to operation of the train on the track; and
determining or adjust at least one of the one or more control adjustments based on the operation information.

20. The method of claim 19, comprising the operation information comprises information relating to one or more of: speed of the train, weight of the train, length of the train, speeds, grade, and grade of the track.
